(19) United States
(12) Patent Application Publication
(10) Pub. No.: US 2019/0184734 A1
(43) Pub. Date: Jun. 20, 2019

(54) ART KITS

(71) Applicant: AMANDA FENNELL, SOUTHAMPTON, NY (US)

(72) Inventor: AMANDA FENNELL, SOUTHAMPTON, NY (US)

(21) Appl. No.: 15/845,733

(22) Filed: Dec. 18, 2017

(51) Int. Cl. B44D 3/00

(52) U.S. Cl. CPC B44D 3/00

(57) ABSTRACT

An art kit to create artwork limited only by the creator's imagination irrespective of the creator's artistic skills, knowledge, and artistic experience comprising at least one substrate, at least one masking appliqué, at least one set of art media and at least one picture frame configured to fit around said at least one substrate. The substrate can chosen from the group of substrates consisting of paper, cardboard, textile, canvas. The masking appliqué comprises a thin flexible plastic sheet held on a backing sheet by a low tack adhesive and at least one shape capable of providing a pictorial theme to the artwork, so distinctive that the art kit can function as a souvenir.

### CROSS-REFERENCE TO RELATED APPLICATIONS

This application claims priority from U.S. Provisional Application Ser. No. 62/435,259 filed on Dec. 16, 2016, and incorporated by reference in its entirety, as if more fully set forth herein.

### BACKGROUND OF THE INVENTION

### Field of Invention

The present invention relates to the creation of art work capable of being framed. More particularly, the present invention relates to art kits for use by amateur artists of all ages, especially school aged youth, aspiring adults and elder adults, to create aesthetically pleasing identifiable and recognizable artwork, which can also function as “individual artistic memoirs”, souvenirs, favors, or gifts, framed and ready to display.

### Prior Art

Art is a visual language that crosses all ethnic, cultural and language barriers. The ability to create, use and read art is a “built-in” trait. Many people disregard this trait, however, as they feel they do not possess the ability to produce identifiable unique artwork. As a result they miss out on the benefits that art provides, many of them therapeutic, including but not limited to the benefit of experiencing an increased self-confidence, and reduced stress.

Frame-able artwork in particular, as in the form of sketches and paintings, contributes greatly to, and positively impacts the quality of everyone's life; particularly if the artwork is of one's own creation. Many individuals however, disregard the usefulness of creating art because they disregard their built-in trait to create art, and as a result lack the confidence to create identifiable, recognizable artwork.

The disregarding of humans' “built-in”, art-creating trait has led to certain generally accepted, erroneous, public beliefs. One such belief is that it takes both knowledge and experience to create an aesthetically pleasing work of art. Or, only the acquisition of the right skills and tools, coupled with patience, can turn out artwork that is attractive and life-enhancing. Thus, with the exception of truly talented and gifted individuals, not everyone develops the ability, or the knowledge, or the courage to produce paintings or works that could be considered art, or a recognizable, identifiable subject for the viewer to read. Even more importantly however, is that not everyone have the ability to produce works of art on site, at the venue they are visiting, or the events that they are attending, i.e., works of art that can also function as souvenirs, favors, or gifts.

A souvenir (from French for a remembrance or memory), a memento, keepsake, or token of remembrance is an object a person, such as a traveler, may acquire for the memories that person associates with it. A souvenir can be any object that can be collected, or purchased, and transported home by the traveler as a memento of a visit. The souvenir itself may have intrinsic value, or simply be a symbol of past experience. The tourism industry designates tourism souvenirs as commemorative merchandise associated with a location, often including geographic information and usually produced in a manner that promotes souvenir collecting.

Throughout the world, the souvenir trade is an important part of the tourism industry serving a dual role. It helps improve the local economy, and it allows visitors to take with them a memento of their visit, ultimately to encourage an opportunity for a return visit, or to promote the locale to other tourists as a form of word-of-mouth marketing. Perhaps the most collected souvenirs by tourists are photographs, as a medium to document specific events and places for future reference.

Souvenirs as objects are usually mass-produced merchandise such as clothing, T-shirts and hats; collectibles such as postcards, refrigerator magnets, miniature figures; or household items such as mugs, bowls, plates, ashtrays, egg timers, spoons, notepads, plus many others. Souvenirs may also include non-mass-produced items like folk art; local artisan handicrafts; objects that represent the traditions and culture of the area; non-commercial, natural objects like sand from a beach; and anything else that a person attaches nostalgic value to and collects among his or her personal belongings.

With very few exceptions, as for example when the traveler is an experienced artist, souvenirs don't normally include art work created by the travelers themselves. Either because they lack the skills, knowledge, experience or courage to create the art work; or because they don't have the time or the tools with them to create the art work, as they are traveling.

An individually and personally produced, artistic memoir or art work can serve as a souvenir or a memento to capture or preserve the emotions and feelings of its creator at a particular time. When creating the art work, the creator also establishes a vivid memory. The brain starts recording fragments of thought, feeling, and memory, that can be re-visited when its creator views the art work again in the future. This recording creates a bond between the art work and the viewer's recollection of the event, time, place etc.

In addition, the art work can be passed down through generations to preserve the memories of its creator, as for example when art work is kept to preserve the youth of children, or the hand drawn scribble from an elder. These artistic memories can be placed in box to store and use when history is recounted and continuity from one generation to the next is established. It can, and often serve(s) as a time line for individual and family history. Yet the importance of a personally created artistic memoir as a souvenir is downplayed and highly overlooked.

The prior art discloses a number of art kits that help amateur artists create aesthetically pleasing paintings. For example, there are “painting by numbers” type art kits. Such kits comprise a base sheet or a substrate that acts as the canvas, with an outline of a particular item or scene. What the scene should look like in the end is usually pictured on the box of the art kits. The outline delineates a surface area that needs to be painted in. The surface area is further divided into smaller sections, each section printed with an identification number, all sections interlocking with each other like a puzzle to create the scene to be painted. The identification number in each section designates the appropriate paint color, which should be applied to the section. The artist matches the identification number of each of the sections to the corresponding numbered paint color, dips his or her paintbrush in that color, and proceeds to paint all of the small sections within the outline, bearing the same identification number as the number corresponding to the color paint. Painting number by number, the artist is able to reproduce the scene as it appears pictured on the box.

“Painting by number” art kits are tedious, boring, and time consuming because they require relatively careful application of paint, without any thinking, creativity, or initiative. The paint must be retained within the boundary lines of each designated area. There is no way to “fix” a wrong placement of paint. Generally, the final painting is displeasing and unacceptable, if the boundaries are not observed.

“Painting by number” art kits represent the vision of the person who created them. The scenes contained in them and the colors used to fill in the “boxes” do not spring from the amateur painter's imagination. All they teach is how to robotically fill in the gaps. These kits stifle imagination and tend to be extremely boring and uninteresting to complete.

Nor are such kits practical to use. Usually, they have to be brought home, or to the amateur painter's working space. They need to be set up and prepped. They may require an easel and either oil based or acrylic paints or water colors with special brushes. They cannot be completed without some painting skills to keep the color within the sections' boundaries, if the final art work will have any semblance of artistic merit, similar to the artwork on the cover of the packaging of the art kit.

As U.S. Pat. No. 3,284,927 states, “Painting by number” art kits “deny their users the function of mixing colors, matching colors, or applying artistic license to the color or distribution of color or intensity thereof in the various picture areas.” Further, none of these art kits allow travelers to produce works of art on-site where they are visiting, of the venue they are visiting, that can also function an individual artistic memoir, souvenirs, favors, or gifts.

Art kit improvements are disclosed in a number of patents and patent applications. For example, U.S. Pat. No. 3,284,927 provides a picture painting kit enabling an untrained person to achieve a fully colored painting by artistic method, but without art training or special talent. It comprises an open box structure adapted to be enclosed by a sleeve telescoping cover. The box structure is preferably formed of a paper board material. It embodies a movable easel panel in the form of the rigid rectangular sheet preferably hinged at its lower edge to an inner dividing wall. Foldable flange supports extend from the side edges of the panel to present downwardly and rearwardly extending lock tab to accommodating slots of the walls of the box structure. In this way the easel panel may be swung upwardly from its collapsed position to an easel position. The open box structure presents a rearward compartment for accessibility of saturated and unsaturated color reproductions therein and painting materials in the forward compartment thereof.

U.S. Pat. No. 4,416,632 discloses a paint-by-numbers kit containing a panel board with a non-porous paper mounted thereon. The paper contains thereon a plurality of different unpainted picture areas and a plurality of different water-insoluble portions together constituting an unpainted picture to be painted by a user. Also contained in the kit is a plurality of different water-based paints for coloring the unpainted picture areas. The paints form a layer of transparent color on the non-porous paper of the panel board. Each unpainted picture area is associated with a water-soluble indicia number for indicating to the user which of the different paints to apply to each unpainted picture area. Each different paint is separately identified by a selector number which corresponds to an appropriate indicia number. In using the paint-by-numbers kit, the user wets a paint brush which is supplied with the kit and rubs the wetted paint brush on the paints. The user proceeds to apply the paint to the unpainted picture area until all of the unpainted picture area are colored. The wet water-based paints cause the water-soluble indicia numbers to disappear while allowing the water-insoluble portions to remain visible on the finished picture. Hence, the finished picture is not marred by the presence of indicia numbers and the water-insoluble portions, which are important parts of the completed picture, remain visible.

U.S. Pat. No. 5,788,501 discloses a support material for a painting comprising a substrate, e.g. of paper or card, having on regions thereof a removable masking material to provide pictorial content and to define non-masked regions of substrate which provide a surface for receiving and retaining paint. The masking material is provided on the substrate in the form of a printed layer, applied for instance by screen printing. The preferred masking material is applied as a latex-based fluid and is removable from the substrate by an eraser after application of a water-based paint wash to the entire substrate surface. Optionally the subsequently unmasked regions can be painted to provide additional pictorial detail.

U.S. Pat. No. 8,622,741 discloses a printable multi-purpose form that features detachable pieces, which may be separated and attached to a substrate to create an artwork. The detachable pieces can be connected together using separator pieces and adhesive to form stacked images for the creation of three-dimensional artworks.

However, neither the prior art described above, by way of example, nor any other prior art solve the real problem with these kits. These kits continue to represent the vision of the person who created them. The scenes contained in them do not spring from the amateur painter's imagination. Nor do they represent the amateur artist's personal experience. They continue to stifle imagination to a certain extent, and tend to be extremely boring and uninteresting to complete. They still need to be brought home, to the amateur painter's working space. They need to be set up and prepped. They may require an easel and either oil based or acrylic paints or water colors with special brushes. They cannot be completed without some painting skills, particularly if the final art work will have any semblance of artistic merit, similar to the artwork on the cover of the packaging of the art kit. They continue to deny their users the function of mixing colors, matching colors, or applying artistic license to the color or distribution of color or intensity thereof in the various picture areas. Each and every kit produces the same exact outcome. Most importantly, none of these prior art kits allow travelers to produce works of art on site, at the locations and venues they are visiting, or the events that they are attending, which can also function as an individual artistic memoir, souvenirs, favors, or gifts.

Accordingly, there still exists a need for art kits, which allow amateur artists to use their imagination and “built-in trait” to express themselves through art work they create based on their own vision and personal experience, irrespective of the level of artistic skills, knowledge, and artistic experience they may or may not have. There is still a need for an art kit that will produce identifiable recognizable artworks, capable of boosting the self-esteem of their creators. There is still a need for art kits that allow the artists' expression through art work to happen, while they are still on site, at the place they are visiting, or the venue and event they are attending. Finally, there is still a need for art kits that result in a final artwork, capable of being framed in real time, as an individual artistic memoir, a souvenir or memento of the artists' experience after it is complete, to be preserved for generations to come.

### SUMMARY OF THE INVENTION

Accordingly, it is an object of the present invention to provide art kits that permit amateur artists, of all ages, especially school-age youth, aspiring adults and elders to use their “built-in trait” to create a recognizable, identifiable unique painting, irrespective of their level of artistic knowledge, skills, and expertise, or total lack thereof.

It is a further object of the present invention to provide art kits that will capture the vision of the amateur artists who use them, helping them to create identifiable recognizable subject matter.

It is still another object of the present invention to provide art kits that will result in artwork from the creator's own imagination and experience, creating individual artistic memoirs that are unique to its creator.

It is yet another object of the present invention to provide art kits that stimulate and encourage the imagination and self-confidence of the artists who use them, irrespective of their level of artistic knowledge, skills, and expertise or total lack thereof.

It is a further object of the present invention to provide art kits that will permit their users the function of mixing colors, matching colors, or applying artistic license to the color or distribution of color or intensity thereof in the various picture areas, without fear or concern, and with total artistic license.

It is still another object of the present invention to provide art kits that will allow travelers to produce works of art on site, at the locations and venues they are visiting, or the events that they are attending, which works of art can also function as individual artistic memoirs, souvenirs, favors, or gifts.

It is yet another object of the present invention to provide art kits whose outcome will always be an identifiable subject, as well as unique to the individual creator.

In accordance with the present invention there is provided an art kit comprising a substrate to act as a canvas; at least one masking appliqué to provide pictorial content and to define non-masked regions on the substrate, for receiving color and decorations, retain color and define the pictorial contents; tools to paint, color (art media) and decorate the non-masked regions of the substrate; and a picture frame configured to fit around the substrate once the art work is done. The at least one masking appliqué may comprise a thin, flexible plastic sheet held on a backing sheet by a low tack adhesive, which will be removably fixed on the substrate to define a non-masked region on the substrate, all around the appliqué. Paint, color, decorations, stickers, and so on will then be applied to the non-masked region of the substrate all around the masking appliqué. Thereafter, the masking appliqué is removed to create a sharply defined image, flanked and outlined by the decorated, previously non-masked regions of the substrate. Optionally, the negative space created by the removal of the appliqué, is then filled in with art media, such as paint, color, decorations, stickers and so on. This creates the theme, or topic of the artwork, with the assurance that it will be an identifiable, recognizable subject by a viewer. The result is artwork ready to be exhibited and admired within the frame provided in the art kit.

These and other objects, advantages, features, and characteristics of the invention will be apparent from the following description of the preferred embodiments, considered along, with the accompanying drawings.

### BRIEF DESCRIPTION OF THE DRAWINGS

It is believed that the present invention will be better understood from the following detailed description taken in conjunction with the accompanying drawings, in which the numerals represent identical elements and wherein:

FIG. 1 comprises top plan views showing use of one embodiment of the inventive art kit to produce artwork of a tall ship;

FIG. 2 comprises top plan views showing use of another embodiment of the inventive art kit to produce artwork of a lighthouse;

FIG. 3 comprises top plan views showing use of yet another embodiment of the inventive art kit to produce artwork of a vase with flowers;

FIG. 4 comprises top plan views showing use of still another embodiment of the inventive art kit to produce artwork of a robot/lighthouse/rocket ship. And,

FIG. 5 comprises top plan views showing use of still another embodiment of the inventive art kit to produce artwork of a duck.

FIG. 6 comprises a flow chart of the process to use the inventive art kit.

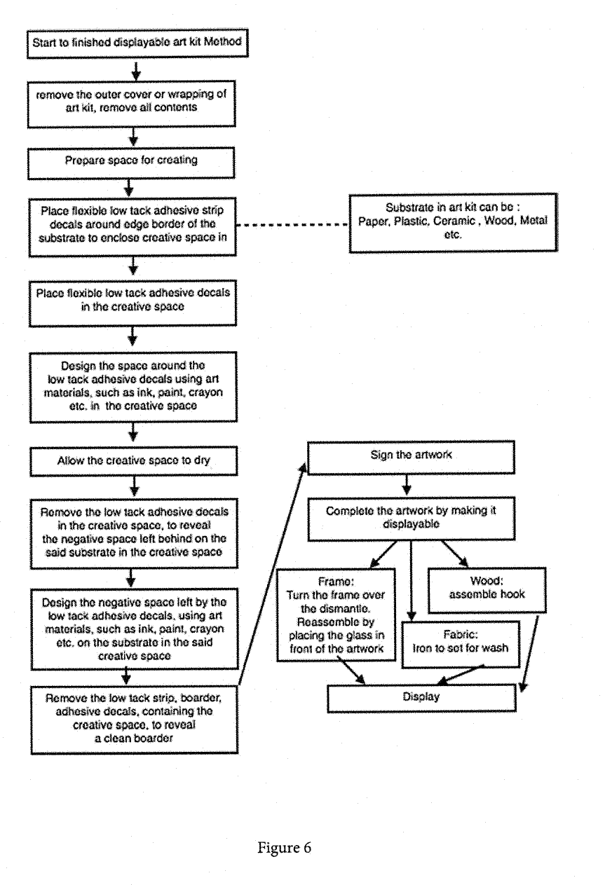

### LIST OF ELEMENTS AND THEIR RESPECTIVE IDENTIFYING NUMERALS

| NO. | ELEMENT |
|---|---|
| 10 | Art kit |
| 20 | Substrate |
| 30 | Masking appliqué |
| 40 | Art media |
| 50 | Frame |

### DETAILED DESCRIPTION OF THE PREFERRED EMBODIMENT

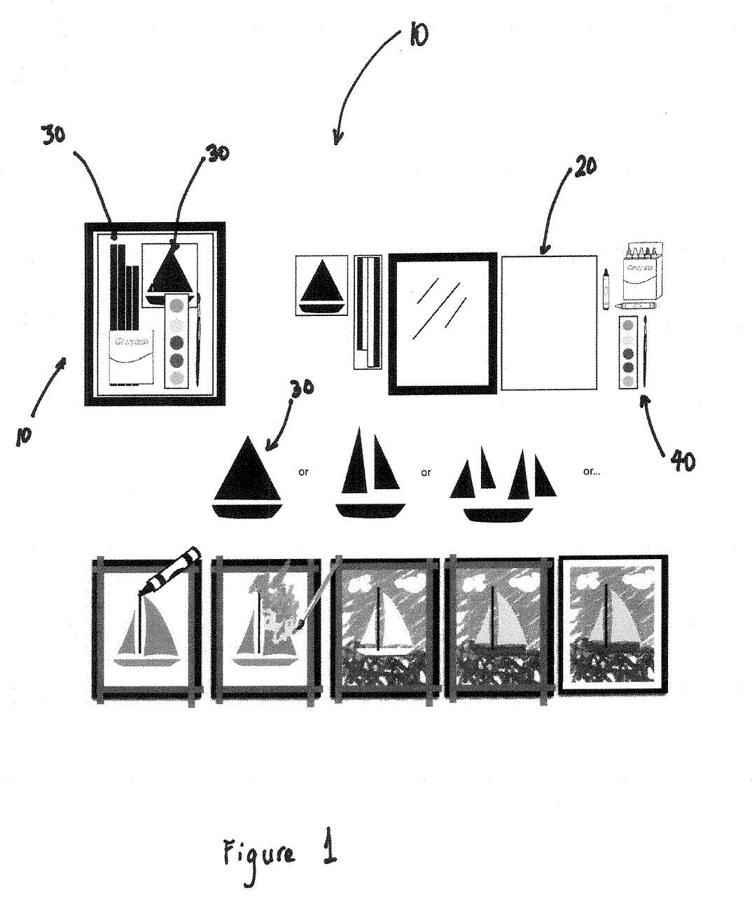

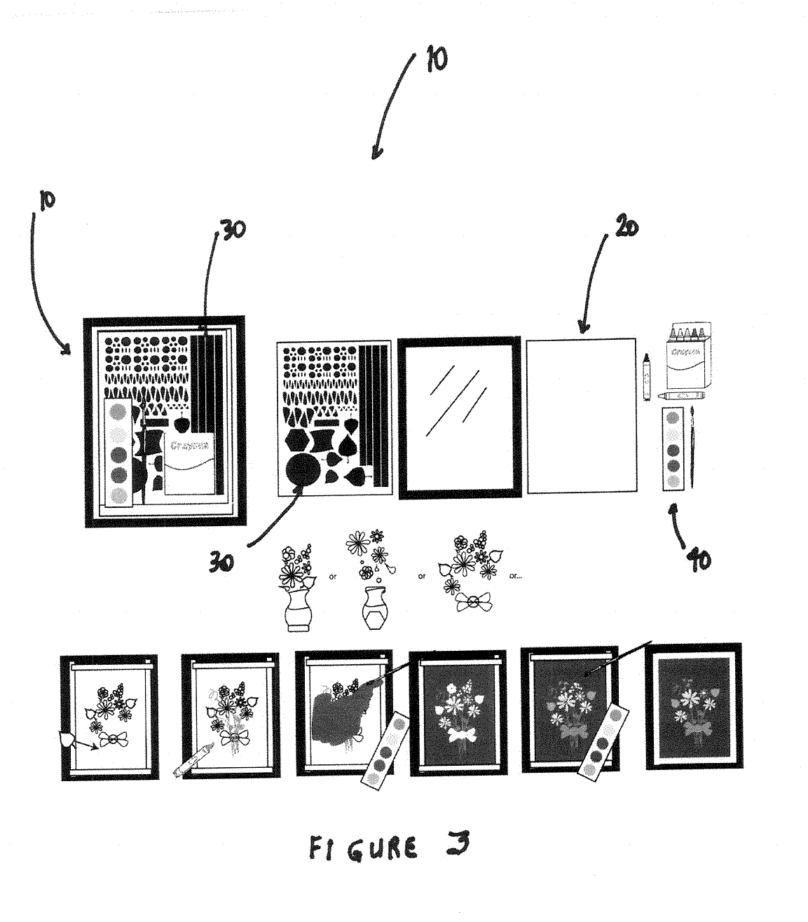

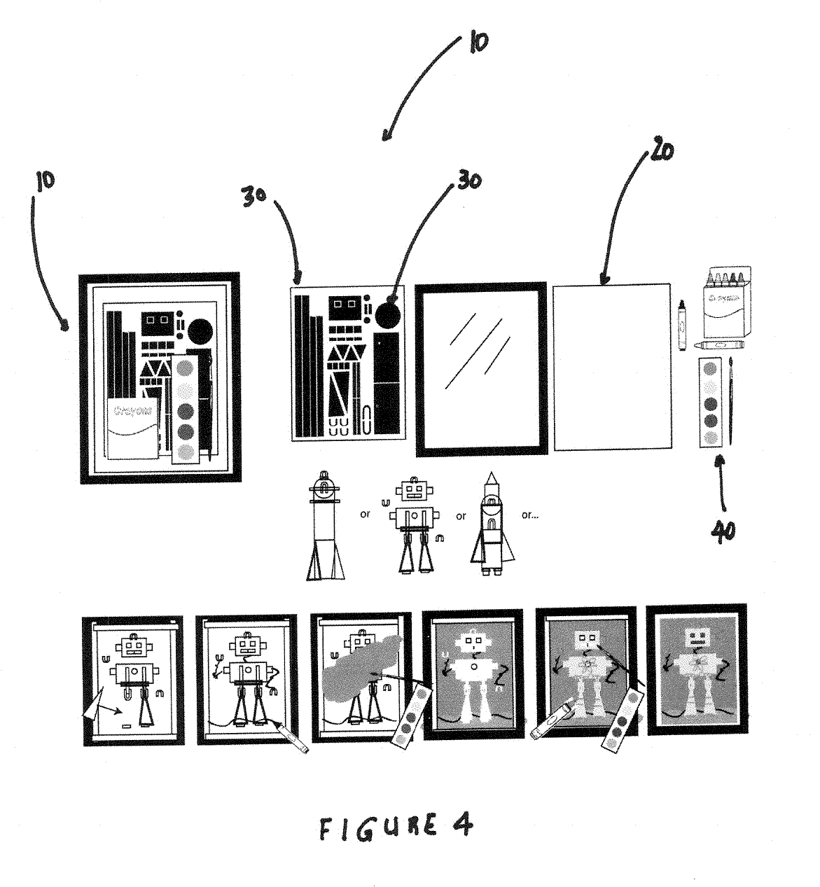

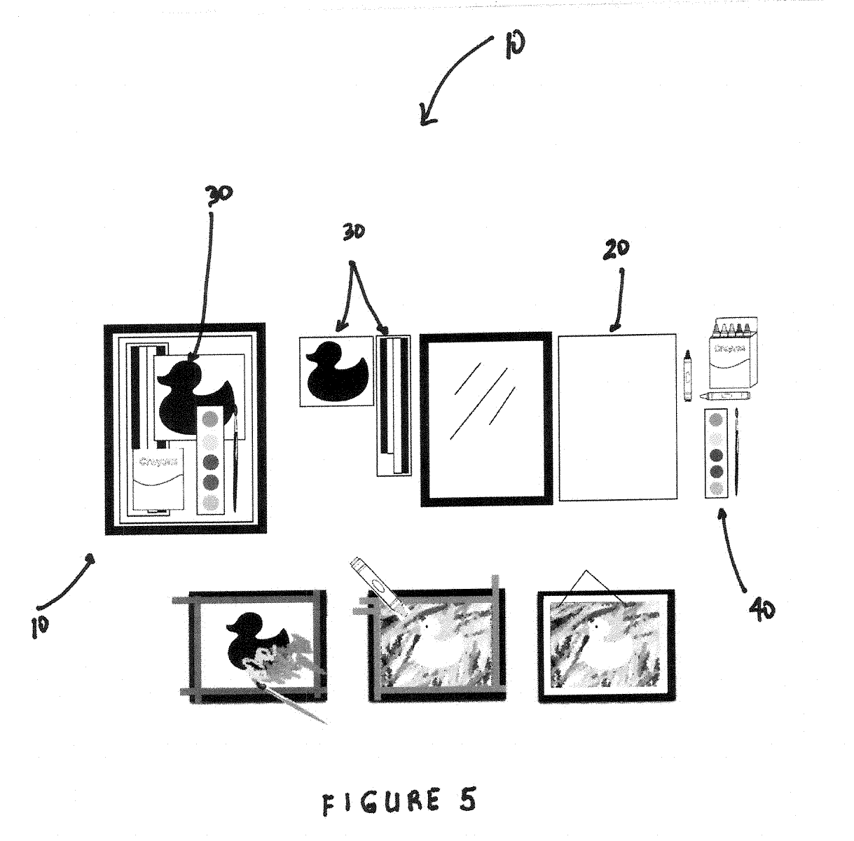

Referring more specifically to FIGS. 1-5, they each generally depict a different embodiment of the art kit respectively, in accordance with the present invention at 10. The figures show how each of the embodiments of the art kit allow amateur artists to use their imagination and “built-in trait” to express themselves through art work they create based on their own vision and personal experience, irrespective of the level of artistic skills, knowledge, and artistic experience they may, or may not have. The inventive art kits produce clearly identifiable recognizable works of art, with the potential of boosting the self-esteem of their creator. While the kits suggest how their components can be used to create art, such suggestions are meant to be examples only. They do not limit the artists' expressions. If these art kits are available at a particular venue, they allow the artists' expression through art work to happen, while they are still on site, at the venue, when visiting. These art kits allow the final artwork to be framed in real time, on the spot and act as an individual artistic memoir, a souvenir or memento of the artists' experience at the venue, after it is complete, to be preserved for generations to come.

Referring more specifically to FIGS. 1-5, the inventive art kit comprises at least one substrate 20, at least one masking appliqué 30, at least one set of art media 40, and at least one picture frame 50 configured to fit around said at least one substrate once the art work is done and ready to be displayed.

The substrate 20 is the blank canvas on which the artwork will be created. It is the support material for the painting. It could be paper of varying thickness, a cardboard, or painting canvas. It must be capable of retaining art media 40, which may be paint, water colors, pencil color, chalk, crayons, stickers and so on. Good examples of papers that could act as a substrate are water color papers with (ROUGH).(NOT) and (HP) surfaces. Various textured and untextured paper can also be used as substrates. In all cases the card/paper substrate may be tinted, if desired, with various colors.

The at least one masking appliqué 30 comprises a thin, flexible plastic sheet held on a backing sheet by a low tack adhesive. Optionally, the appliqué may be a single shape or it may comprise multiple geometrical and free-form shapes that can be combined into various items capable of providing a pictorial theme to the artwork. The appliqué 30 is removed from its backing sheet and removably fixed on the substrate 20 to define both a masked and a non-masked region on the substrate 20. The non-masked region surrounds the masked region formed by the placement of the appliqué 30 on the substrate 20. The appliqué 30 provides the pictorial content for the artwork. It is generally impermeable to the art media 40, so that it provides an effective barrier to prevent or inhibit the art media from reaching the masked regions of the substrate 20.

The art media 40, such as paint, water colors, decorations, stickers, and so on can then be freely, unilaterally and arbitrarily applied to the non-masked region of the substrate 20 all around the masking appliqué 30. The sky is the limit on the ways the art media 40 can be used or applied on the substrate. The only thing limiting the application of the art media 40 on the substrate 20, is the author/creator's imagination and the appliqué 30. Thereafter, the masking appliqué 30 is removed to create a sharply defined image, flanked and outlined by the decorated, previously non-masked regions of the substrate 20. Optionally, the negative space created by the removal of the appliqué, is then also filled in with art media, such as paint, color, decorations, stickers and so on. See for example, FIG. 1 where the sails of the sailboat are colored yellow, after the appliqué 30 is removed. The appliqué 30 and the negative space it leaves behind, creates the theme or topic of the artwork, with the assurance that it will be an identifiable, recognizable subject by a viewer, once the work of art is completed. The result is artwork ready to be exhibited and admired within the frame provided in the art kit.

Referring more specifically to FIG. 1 the process of using the inventive art kit to create artwork with a nautical theme, comprises the following steps: a) placing the strip appliqués 30 around the border of the substrate 20, making sure that they are flat; b) using the remaining geometrically shaped appliqués 30 to create, for example, a tall ship, by placing them on the substrate 20, tacky side down, so that they do not shift around on the surface of the substrate 20. The placement of the appliqués 30 define both a masked and a non-masked region on the substrate 20, the masked region being the tall ship; c) decorating the non-masked region on the substrate 20 with the art media, i.e., crayons, water paints, oil paints, pencils, stickers and so on, by drawing in additional elements such as a mast and clouds and by painting in the sky or the ocean, without worry, even over the appliqués, which protect the masked area; d) allowing the artwork to dry if necessary; e) removing the geometrically shaped appliqués 30, and if desired decorating the blank space revealed by the appliqués' removal; f) removing the strip appliqués 30 from around the border of the substrate 20; g) signing and dating the artwork; h) mounting the artwork within the frame provided in the art kit; and i) hanging the frame to display the artwork. If the artwork is completed, as for example, at a maritime museum, then the artwork can be further marked with information about the museum, the date of the visit, etc., and the artwork can function as a souvenir at the museum.

There are no limits on how the non-masked area of the substrate can be decorated. There are no limits on how the geometrically shaped appliqués 30 can be used to create a nautical theme. The possibilities are endless limited only by the author's imagination. The art kit only liberates what its users can do.

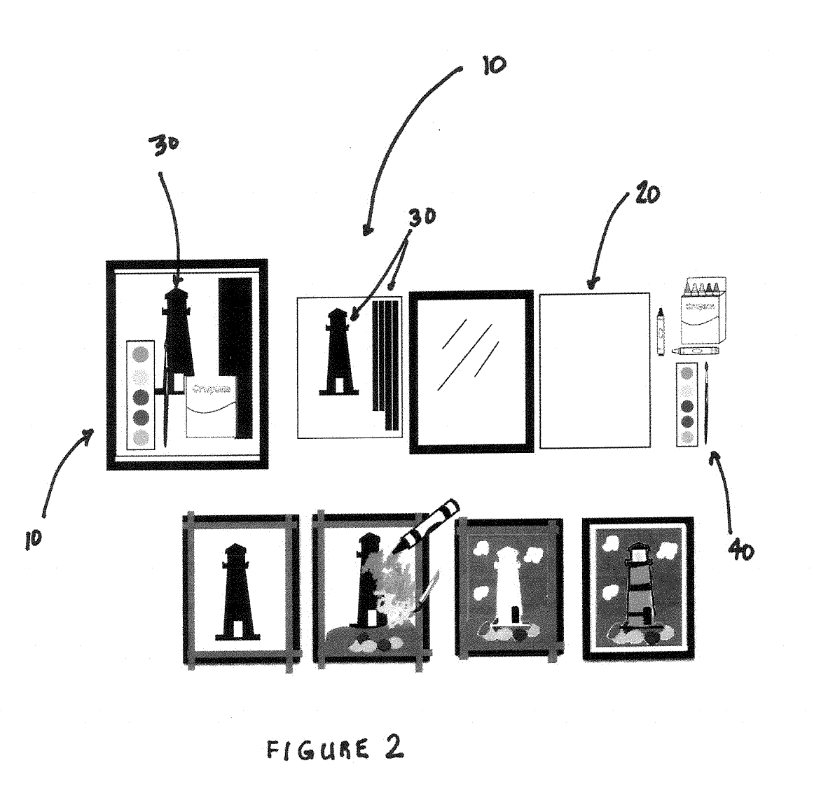

Referring more specifically to FIG. 2 the process of using the inventive art kit to create artwork with a lighthouse theme, comprises the following steps: a) placing the strip appliqués 30 around the border of the substrate 20, making sure that they are flat; b) using the remaining geometrically shaped appliqués 30 to create, for example, a lighthouse, by placing them on the substrate 20, tacky side down, so that they do not shift around on the surface of the substrate 20. The application of the appliqués 30 on the substrate 20 define both a masked and anon-masked region on the substrate 20, the masked region being the lighthouse. The appliqués 30 leave very little room for error because they are pre-cut and so generic that anyone can put them together; c) decorating the non-masked region on the substrate 20 with the art media, i.e., crayons, water paints, oil paints, pencils, stickers and so on, by drawing in additional elements such as clouds and rocks, and by painting in the sky or the ocean, without worry, even over the appliqués 30, which protect the masked area; d) allowing the artwork to dry if necessary; e) removing the geometrically shaped appliqués 30 and if desired decorating the blank space revealed by the appliqués' removal; f) removing the the strip appliqués 30 from around the border of the substrate 20; g) signing and dating the artwork; h) mounting the artwork within the frame provided in the art kit; and i) hanging the frame to display the artwork. Once again if the artwork is completed at a maritime tourist venue, as for example during a visit to a lighthouse, or a maritime museum, then the artwork could be further marked with the date of the visit or the name of the venue. It can now function as a souvenir of the venue noted thereon.

Once again, there are no limits on how the non-masked area of the substrate can be decorated. There are no limits on how the geometrically shaped appliqués 30 can be used to create a light house theme. The possibilities are endless limited only by the author's imagination. The art kit only liberates what its user can do.

Referring more specifically to FIGS. 2-5 the processes of using the inventive art kits to create artwork with flower, robot/lighthouse/rocket ship and duck themes, respectively, comprise steps that are similar if not identical to the steps set forth above.

Another embodiment of the art kit comprises a plurality of substrates 20, a plurality of masking appliqués 30, a plurality of sets of art media 40, and a plurality of picture frames 50 configured to fit around any one of the plurality of substrates 20, once the art work on any one of said substrates is done and ready to be displayed. The components can be packaged all together, or laid out all together to accommodate more than one author or creator, as for example when the art kit is used as part of an entertainment or education event attended by a group of participants, as for example a “wine night”, or fund-raising social event. Or, the components can be packaged all together or laid out to provide a single author with the flexibility of creating multiple works with multiple art themes.

Another embodiment of the art kit comprises a multiplicity of substrates 20, a multiplicity of masking appliqués 30, a multiplicity of components or sets of components of art media 40, and a multiplicity of picture frames 50 configured to fit around any one of the multiplicity of substrates 20, once the art work on any one of said substrates is done and ready to be displayed by its creator. Due to their number, each multiplicity of each of the components can be marshaled and displayed for access by potential creators or authors within large containers such as bins, buckets, barrels, and so on, either at tables, kiosks, or booths, or stores. Thus, potential artists, authors, creators can just walk up to the tables, kiosks or booths, or into the stores, examine all of the components displayed in their containers, choose which of the components appeal to them, follow the process set forth above to create artwork, frame the artwork and leave the kiosk, or booth, or store with a final work of art ready to be displayed and enjoyed. The tables, kiosks, booths or stores could be set up within large themed venues, as for example within large amusement parks, and the multiplicity of components of the art kit can provide the potential creators/authors/artists with the ability to create similarly themed artwork, capable of acting as souvenirs of the venues, within which they are created.

There is no question that the inventive art kit described herein above, accomplishes all of its objectives. It permits amateur artists to use their “built-in trait” to create a recognizable, identifiable unique work of art, irrespective of their level of artistic knowledge, skills, and expertise. There are no formulas to follow and no numbered boxes to fill in. It captures the vision of the amateur artists who use them, helping them create identifiable recognizable subject matter. Because it is tabula rasa, a blank slate, it results in artwork from the creator's own imagination and experience, creating individual artistic memoirs that are unique to its creator. It stimulates and encourages the imagination and self-confidence of the artists who use them, irrespective of their level of artistic knowledge, skills, and expertise. It permits their users to mix colors, match colors, and apply artistic license to the color or distribution of color or intensity thereof in the various picture areas, without fear or concern, and with total artistic license. When the themes of the art kits are matched to various venues of interest, anywhere in the world, the art kit allows travelers to produce works of art on site, at the locations and venues they are visiting, or the events that they are attending, which works of art can also function as individual artistic memoirs, souvenirs, favors, or gifts. Its outcome will always be an identifiable subject, as well as unique to its individual creator.

While particular embodiments of the invention have been illustrated and described in detail herein, they are provided by way of illustration only and should not be construed to limit the invention. Since certain changes may be made without departing from the scope of the present invention, it is intended that all matter contained in the above description, or shown in the accompanying drawings be interpreted as illustrative and not in a literal sense. Practitioners of the art will realize that the sequence of steps and the embodiments depicted in the figures can be altered without departing from the scope of the present invention and that the illustrations contained herein are singular examples of a multitude of possible depictions of the present invention.

Accordingly, I claim:

1. An art kit comprising at least one substrate, at least one masking appliqué, at least one set of art media and at least one picture frame configured to fit around said at least one substrate, whereby said art kit can be used to create artwork limited only by the creator's imagination irrespective of the creator's artistic skills, knowledge, and artistic experience.

2. The art kit in accordance with claim 1, wherein said substrate comprises the canvas for said artwork.

3. The art kit in accordance with claim 1, wherein said substrate is chosen from the group of substrates consisting of paper, cardboard, textile, canvas.

4. The art kit in accordance with claim 1, wherein said masking appliqué comprises a thin flexible plastic sheet held on a backing sheet by a low tack adhesive.

5. The art kit in accordance with claim 4, wherein said masking appliqué further comprises at least one shape capable of providing a pictorial theme.

6. The art kit in accordance with claim 5, wherein said pictorial theme of said masking appliqué is so distinctive that the art kit can function as a souvenir.

7. The art kit in accordance with claim 2, wherein said masking appliqué comprises a thin flexible plastic sheet held on a backing sheet by a low tack adhesive.

8. The art kit in accordance with claim 7, wherein said masking appliqué further comprises at least one shape capable of providing a pictorial theme.

9. The art kit in accordance with claim 3, wherein said masking appliqué comprises a thin flexible plastic sheet held on a backing sheet by a low tack adhesive.

10. The art kit in accordance with claim 9, wherein said masking appliqué further comprises at least one shape capable of providing a pictorial theme.

11. The art kit in accordance with claim 1, wherein said one set of art media comprises paint, water colors, pencil color, chalk, crayons, and stickers.

12. The process of creating artwork with a particular theme, using an art kit having at least one substrate, at least one masking appliqué, at least one set of art media and at least one picture frame configured to fit around said at least one substrate, said process comprising the following steps: a) placing strip appliqués around the border of said substrate making sure that said strip appliques are flat; b) using said remaining geometrically shaped appliqués to create a particular theme, by placing them on said substrate to mask certain of its area; c) decorating the non-masked area on said substrate with said art media, even over said appliqués; d) removing said geometrically shaped appliqués; and e) mounting the artwork within said frame.

13. The process in accordance with claim 12, wherein there are a multiplicity of substrates, a multiplicity of appliques, a multiplicity of art media and a multiplicity of frames configured to fit around any one of said multiplicity of substrates from which to choose to create said artwork.

14. The process in accordance with claim 13, wherein there is a plurality of substrates, a plurality of appliques, a plurality of art media and a plurality of frames configured to fit around any one of said plurality of substrates from which to choose to create said artwork.

15. An art kit comprising a multiplicity of substrates, a multiplicity of masking appliqués, a mutliplicity of art media and a multiplicity of picture frames configured to fit around any one of said multiplicity of substrates, marshaled and displayed for access by potential artists within storage containers displayed in such a manner that said potential artists can examine all of the components displayed in their containers, choose which of the components appeal to them, use the components to create artwork, frame the artwork into final work of art ready to be displayed and enjoyed.

16. The art kit in accordance with claim 15, wherein each of said multiplicity of masking appliqués further comprise at least one shape capable of providing a pictorial theme.

17. The art kit in accordance with claim 16, wherein said pictorial theme of said masking appliqués is so distinctive that the art kit can function as a souvenir of the venue where the art kit is used.
